(19) United States
(12) Patent Application Publication
(10) Pub. No.: US 2023/0220176 A1
(43) Pub. Date: Jul. 13, 2023

(54) FOAMED BODY, FOAMED SHEET, MANUFACTURE, AND METHOD FOR PRODUCING FOAMED BODY

(71) Applicants: Yuka Mizoguchi, Shizuoka (JP); Taichi Nemoto, Shizuoka (JP); Hideki Sugiura, Shizuoka (JP); Shinya Nakayama, Shizuoka (JP); Hiroshi Yamashita, Shizuoka (JP)

(72) Inventors: Yuka Mizoguchi, Shizuoka (JP); Taichi Nemoto, Shizuoka (JP); Hideki Sugiura, Shizuoka (JP); Shinya Nakayama, Shizuoka (JP); Hiroshi Yamashita, Shizuoka (JP)

(73) Assignee: Ricoh Company, Ltd., Tokyo (JP)

(21) Appl. No.: 18/004,420

(22) PCT Filed: Jun. 25, 2021
(86) PCT No.: PCT/IB2021/055639

§ 371 Date: Jan. 5, 2023

(30) Foreign Application Priority Data
Jul. 31, 2020 (JP) 2020-130964

(51) Int. Cl. C08J 9/12; C08J 9/00; C08J 5/18; C08K 3/36; C08K 9/00; C08G 63/08

(52) U.S. Cl. CPC C08J 9/122; C08J 9/0066; C08J 9/009; C08J 5/18; C08K 3/36; C08K 9/00; C08G 63/08; C08J 2203/06; C08J 2367/04; C08K 2201/005; C08K 2201/011; C08G 2101/00

(57) ABSTRACT

A foamed body includes a polylactic acid resin. An amount of the polylactic acid resin is 99.5% by mass or greater relative to a total amount of organic matter in the foamed body. A gel fraction of the foamed body is 0.1% or less. An expansion ratio of the foamed body is 5 times or greater.

### TECHNICAL FIELD

The present disclosure relates to a foamed body, a foamed sheet, a manufacture, and a method for producing a foamed body.

### BACKGROUND ART

Recently, global warming caused by an increase in the carbon dioxide concentration in the atmosphere has become a worldwide issue. In each of the industries, a technology for reducing the carbon dioxide emission to the atmosphere has been developed. Under such circumstances, in the field of plastic products, general-purpose plastics produced from petroleum-derived raw materials have caused a problem because such plastics generate and release carbon dioxide to the atmosphere as the plastics are incinerated after use, which is considered as one of the factors for increasing the amount of carbon dioxide in the atmosphere.

Therefore, materials or plastics using plant-derived raw materials have been currently attracted attentions from the viewpoint of carbon neutral. Among the plant-derived raw materials, characteristics of polylactic acid, which has biodegradability and uses a plant-derived raw material, have attracted keen attention in recent years.

In order to process the polylactic acid into various shapes, such as a bag, a container, and a tray, according to the intended use, a widely performed practice is to process the polylactic acid into a sheet in advance. However, the polylactic acid is not easily molded. Therefore, modifications of polylactic acid and polylactic acid sheets have been performed by blending with other resins (see, for example, PLT 1).

Upon processing polylactic acid into various shapes, moreover, use of a foamed body of polylactic acid has been considered in order to reduce the amount of the resin and achieve light weight (see, for example, PLTs 2 to 5).

### CITATION LIST

### Patent Literature

### [PTL 1]

Japanese Unexamined Patent Application Publication No. 2007-46019

### [PTL 2]

Japanese Patent No. 6361284

### [PTL 3]

Japanese Unexamined Patent Application Publication No. 2007-145361

### [PTL 4]

Japanese Unexamined Patent Application Publication No. 2009-073955

### [PTL 5]

Japanese Patent No. 6578669

### SUMMARY OF INVENTION

### Technical Problem

The present disclosure has an object to provide a foamed body having biodegradability, and excellent strength and flexibility.

### Solution to Problem

According to one aspect of the present disclosure, a foamed body includes a polylactic acid resin. An amount of the polylactic acid resin is 99.5% by mass or greater relative to a total amount of organic matter in the foamed body. A gel fraction of the foamed body is 0.1% or less. An expansion ratio of the foamed body is 5 times or greater.

### Advantageous Effects of Invention

According to the present disclosure, it is possible to provide a foamed body having biodegradability, and excellent strength and flexibility.

### BRIEF DESCRIPTION OF DRAWINGS

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

FIG. 1 is a phase diagram depicting a state of a substance relative to temperature and pressure.

FIG. 2 is a phase diagram for defining a range of a compressive fluid.

FIG. 3 is a schematic view illustrating a continuous foaming device used for production of the foamed body of the present disclosure.

FIG. 4 is a schematic view illustrating a continuous foaming device used for production of the foamed body of the present disclosure.

### DESCRIPTION OF EMBODIMENTS

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

### (Foamed Body)

The foamed body of the present disclosure includes a polylactic acid resin (hereinafter may be referred to as “polylactic acid”) and preferably further includes inorganic particles. The foamed body may further include other components according to the necessity.

Foamed bodies and foamed sheets of a polylactic acid resin have been considered and studied so far. The foamed body is preferable because a resin can be light weight. However, it has been known that aliphatic polyester such as polylactic acid sharply reduces in viscosity at a temperature around a melting point thereof and that it is difficult to foam the aliphatic polyester. Addition of an organic material-based crystal nucleating agent has been considered in order to increase an expansion ratio, but there is a problem with difficulty in separating a foamed body into a biodegradable material and others when the foamed body is recycled. In order to increase a viscosity at a temperature near a melting point, a conceivable option is to use a crosslinking agent or to use a polylactic acid resin having a high molecular weight. However, use of the crosslinking agent may slow a biodegradation speed or may result in insufficient recycling performance. Moreover, an increase in the expansion ratio is limited only by increasing the molecular weight of the polylactic acid for use.

As described above, it has been considered that production of a foamed body and foamed sheet of polylactic acid, which include polylactic acid as much as possible and have a high expansion ratio, is difficult to achieve.

The present inventors have studied to obtain a foamed body, which can solve the above-described problems, has biodegradability, and has excellent strength and flexibility. As a result of the studies, the present inventors have found that a foamed body having a high expansion ratio and including a large amount of a polylactic acid resin can be obtained by using a compressive fluid, without using a crosslinking agent. Based on such a finding, the present invention has been accomplished. Since a crosslinking agent is not used in the foamed body, a gel fraction of the foamed body can be made 0.1% by mass or less. Note that, excellent biodegradability means that it is easily recycled. In other words, excellent biodegradability means excellent recycling performance.

### <Polylactic Acid Resin>

Since the polylactic acid resin is biodegraded by microorganisms (i.e., a biodegradable resin), the polylactic acid resin has attracted attention as an environmentally friendly polymer material giving low environmental loads (see “Structure, physical properties, and biodegradability of aliphatic polyester, Biodegradable Polymer, 2001, Vol. 50, No. 6, pp. 374-377”).

Examples of a monomer constituting the polylactic acid include, but are not limited to, D-lactic acid (D-lactide, D body) and L-lactic acid (L-lactide, L body). These monomers may be modified as long as such modification does not adversely affect polymerization.

Examples of the polylactic acid include, but are not limited to, a homopolymer of D-lactic acid or L-lactic acid, and a copolymer between D-lactic acid and L-lactic acid. These may be used alone or in combination.

The polylactic acid resin may be a polymer obtained by the below-described method, or a ring-opening polymer obtained through ring-opening polymerization of one lactide or two or more lactides selected from the group consisting of D-lactide (D body), L-lactide (L body), and DL-lactide.

The polylactic acid may be appropriately synthesized for use or may be selected from commercial products for use.

### <<Synthesis Method of Polylactic Acid Resin>>

As a synthesis method of the polylactic acid, both a generally known direct method from lactic acid, and a lactide method which goes through a lactide that is a dimer of lactic acid can be used. The polymerization that goes through a lactide is industrially common. In addition, synthesis according to the lactide method is suitable for obtaining high-molecular-weight polylactide, for example, having a weight average molecular weight (Mw) of 300,000 or greater. The lactic acid and lactide for use preferably have high optical purities, in order to obtain high heat resistance. In order to increase crystallization speed and adjust a melting point, a mixture including an optical isomer D body or L body in an amount of about 0.01% by mass or greater but about 5% by mass or less may be used.

Moreover, usable polylactic acid may be polylactic acid whose optical purity is adjusted by obtaining two or more polylactic acids having mutually different optical purities and blending the polylactic acids.

As a production method of the high-molecular-weight polylactide, a direct melt polymerization method of lactic acid, a solid phase polymerization method, and a melt ring-opening polymerization method of lactide have been known. In the present disclosure, the production method is not particularly limited, but a melt ring-opening polymerization method of lactide is considered as a promising method which has a relatively simple production process, has high production efficiency, is more likely to keep a production cost low, yields polylactide having excellent color tone, gives a relatively low amount of impurities, and produces polylactide having excellent stability.

### <<Polymerization Method and Polymerization Device>>

The polylactic acid resin can be produced by polymerizing lactide with heating in an inert atmosphere in the same manner as in conventionally known methods, or can be produced by polymerizing lactide in a compressive fluid. The latter method, i.e., the method where lactide is polymerized in a compressive fluid, is preferable because heating at a high temperature can be avoided and therefore a deteriorated polylactide product is unlikely to be generated. Moreover, the method where lactide is polymerized in a compressive fluid is more preferable because a high molecular weight can be easily achieved.

When the compressive fluid is a state of a supercritical fluid, dissolution or plasticization of a ring-opening polymerizable monomer is accelerated, and a polymerization reaction can be allowed to proceed homogeneously and quantitatively. According to the method where polymerization is performed in a compressive fluid, a target product can be obtained by means of a continuous polymerization device.

### -Initiator-

An initiator is used for controlling the molecular weight of a polymer product obtained by ring-opening polymerization.

The initiator is not particularly limited and may be appropriately selected depending on the intended purpose. For example, the initiator may be any one of mono or polyvalent alcohols of aliphatic alcohols, which may be saturated or unsaturated, as long as the initiator is an alcohol-based initiator.

Examples of the initiator include, but are not limited to, monoalcohol, polyvalent alcohol, and lactic acid ester.

Examples of the monoalcohol include, but are not limited to, methanol, ethanol, propanol, butanol, pentanol, hexanol, heptanol, nonanol, decanol, lauryl alcohol, myristyl alcohol, cetyl alcohol, and stearyl alcohol.

Examples of the polyvalent alcohol include, but are not limited to, dialcohol (e.g., ethylene glycol, 1,2-propanediol, 1,3-propanediol, 1,3-butanediol, 1,4-butanediol, hexanediol, nonane diol, tetramethylene glycol, and polyethylene glycol), glycerol, sorbitol, xylitol, ribitol, erythritol, and triethanolamine.

Examples of the lactic acid ester include, but are not limited to, methyl lactate and ethyl lactate.

These may be used alone or in combination.

### -Catalyst-

A catalyst may be used for synthesizing the polylactic acid resin. The catalyst is not particularly limited and may be appropriately selected depending on the intended purpose. Examples of the catalyst include, but are not limited to, an organic catalyst and a metal catalyst.

The organic catalyst is preferably an organic catalyst, which is free from a metal atom, contributes to a ring-opening polymerization reaction of a ring-opening polymerizable monomer, and is detached and regenerated through reaction with alcohol, after forming an active intermediate with the ring-opening polymerizable monomer. In the case where a ring-opening polymerizable monomer including an ester bond is polymerized, for example, such an organic catalyst is preferably a (nucleophilic) compound that functions as a basic nucleophile, more preferably a nitrogen atom-containing compound, and particularly preferably a nitrogen atom-containing cyclic compound. Specific examples thereof include cyclic monoamine, cyclic diamine (e.g., a cyclic diamine compound having an amidine skeleton), a cyclic triamine compound having a guanidine skeleton, a heterocyclic aromatic organic compound including a nitrogen atom, and N-heterocyclic carbene.

Although a cationic organic catalyst is used for ring-opening polymerization, the cationic organic catalyst extracts hydrogens from a principal chain of a polymer (causing back-biting). Therefore, the molecular weight distribution of the resultant polymer becomes broader and it is difficult to obtain a high-molecular-weight product.

Examples of the cyclic monoamine include, but are not limited to, quinuclidine.

Examples of the cyclic diamine include, but are not limited to, 1,4-diazabicyclo-[2.2.2]octane (DABCO) and 1,5-diazabicyclo(4,3,0)-5-nonen.

Examples of the cyclic diamine compound having an amidine skeleton include, but are not limited to, 1,8-diazabicyclo[5.4.0]undeca-7-ene (DBU) and diazabicyclononene.

Examples of the cyclic triamine compound having a guanidine skeleton include, but are not limited to, 1,5,7-triazabicyclo[4.4.0]dec-5-ene (TBD) and diphenylguanidine (DPG).

Examples of the heterocyclic aromatic organic compound including a nitrogen atom include, but are not limited to, N,N-dimethyl-4-aminopyridine (DMAP), 4-pyrrolidinopyridine (PPY), pyrrocoline, imidazole, pyrimidine, and purine.

Examples of the N-heterocyclic carbene include, but are not limited to, 1,3-di-tert-butylimidazol-2-ylidene (ITBU).

Of these, DABCO, DBU, DPG, TBD, DMAP, PPY, and ITBU are preferable because these organic catalysts receive less influence from steric hindrance, have high nucleophilicity, or have boiling points that allow for removal under reduced pressure.

Of these organic catalysts, for example, DBU is a liquid at room temperature and has a boiling point. In the case where such an organic catalyst is selected, the organic catalyst can be substantially quantitatively removed from the obtained polymer product by performing pressure reduction on the polymer product. Note that, a type of the organic catalyst for use or whether the removal treatment is performed can be determined depending on the intended use of a product.

The metal catalyst is not particularly limited and may be appropriately selected depending on the intended purpose. Examples of the metal catalyst include, but are not limited to, tin-based compounds, aluminum-based compounds, titanium-based compounds, zirconium-based compounds, and antimony-based compounds.

Examples of the tin-based compound include, but are not limited to, tin octylate, tin dibutylate, and tin di(2-ethylhexanoate).

Examples of the aluminum-based compound include, but are not limited to, aluminum acetylacetonate and aluminum acetate.

Examples of the titanium-based compound include, but are not limited to, tetraisopropyl titanate and tetrabutyl titanate.

Examples of the zirconium-based compound include, but are not limited to, zirconium isopropoxide.

Examples of the antimony-based compound include, but are not limited to, antimony trioxide. As the metal catalyst, a metal catalyst sufficiently dried is preferably used. Preferably used is a dried metal catalyst having a moisture content of 100 ppm or lower, preferably 50 ppm or lower, and more preferably 10 ppm or lower.

The weight average molecular weight (Mw) of the polylactic acid is preferably 260,000 or greater and more preferably 260,000 or greater but 700,000 or less. When the weight average molecular weight of the polylactic acid is 260,000 or greater, it is possible to prevent a problem that viscosity of the polylactic acid as melted becomes lower, resulting in insufficient foaming. The weight average molecular weight is more preferably 700,000 or less because it is possible to prevent a problem that recycling efficiency is poor.

The weight average molecular weight of the polylactic acid is measured by gel permeation chromatography (GPC) under the following conditions.

Device: GPC-8020 (available from Tosoh Corporation)

Column: TSK G2000HXL and G4000HXL (available from Tosoh Corporation)

Temperature: 40 degrees Celsius

Solvent: chloroform

Flow rate: 1.0 mL/min

A sample (1 mL) having a concentration of 0.5% by mass is applied, and the weight average molecular weight Mw of the polylactic acid can be calculated from a molecular weight distribution of the polylactic acid as measured under the conditions above, using a molecular weight calibration curve prepared from monodisperse polystyrene standard samples.

In view of biodegradability, an amount of the polylactic acid resin is 99.5% by mass or greater relative to the total amount of organic matter in the foamed body. When the amount of the polylactic acid resin is less than 99.5% by mass, the polylactic acid resin in the foamed body may be biodegraded, but the other components may remain problematically.

In the present disclosure, the organic matter means a compound including a carbon atom, and excludes oxides of carbon and carbonate salts.

Quantification of the organic matter and the inorganic matter is performed in the following manner.

The foamed body is analyzed by a simultaneous thermogravimeter-differential thermal analyzer (TG/DTA). The loss is determined as the organic matter and the residue is determined as the inorganic matter.

### -Measurement by TG/DTA-

Device: TG/DTA 320 (available from Seiko Instruments Inc.)

Heating rate: 10 degrees Celsius/min

Temperature/flow rate: from room temperature to 550 degrees Celsius, in N₂ atmosphere (200 mL/min)

Amount of sample collected: 10 mg

Sample container: standard container formed of Pt

### <Measuring Method of Polylactic Acid Resin Content>

The determination of the polylactic acid resin content in the organic matter is performed by GCMS to calculate the amount from the total peak value of PLA according to the peak area normalization. When the foamed body includes inorganic matter, a value obtained by subtracting the amount of the inorganic matter from the foamed body is determined as organic matter.

### -Measurement by GCMS-

GCMS: QP2010 available from Shimadzu Corporation, Accessory: Py3030D available from Frontier Laboratories Ltd.

Separation columns: Ultra ALLOY UA5-30M-0.25F available from Frontier Laboratories Ltd.

Sample heating temperature: 300 degrees Celsius

Column oven temperature: 50 degrees Celsius (retained for 1 minute), heated at the heating rate of 15 degrees Celsius/min to 320 degrees Celsius (retained for 6 minutes)

Ionization method: Electron Ionization (E.I) method

Detection mass range: 25 to 700 (m/z)

### <Inorganic Particles>

The inorganic particles are preferably included for the purpose of adjusting, for example, the foamed state of the foamed body (the size of bubbles, the amount of foams, and the arrangement of foams). Note that, the inorganic particles may be referred to as a foam nucleating agent or a filler.

Examples of the inorganic particles include, but are not limited to, talc, kaolin, calcium carbonate, layered silicate, zinc carbonate, wollastonite, silica, alumina, magnesium oxide, calcium silicate, sodium aluminate, calcium aluminate, sodium aluminosilicate, magnesium silicate, glass balloon, carbon black, zinc oxide, antimony trioxide, zeolite, hydrotalcite, metal fibers, metal whiskers, ceramic whiskers, potassium titanate, boron nitride, graphite, glass fibers, and carbon fibers. These may be used alone or in combination.

Of these, silica, titanium oxide, and alumina are preferable in view of uniformity of bubble diameters.

The inorganic particles are preferably subjected to a hydrophobic treatment to adjust a difference in polarity from the polylactic acid resin. The hydrophobic treatment is preferably a treatment where a hydrophobic group is chemically bonded using a hydroxyl group present on surfaces of the inorganic particles. Specifically, the hydrophobic-treated inorganic particles can be obtained by treating hydrophilic inorganic particles with a silane coupling agent, such as methyl trimethoxy silane, methyl triethoxy silane, and octyl trimethoxy silane. Examples of commercial products of the hydrophobic-treated silica particles include, but are not limited to, R972, R974, RX200, RY200, R202, R805, and R812 (all available from NIPPON AEROSIL CO., LTD.).

Moreover, examples of commercial products of the hydrophobic-treated titania particles include, but are not limited to: P-25 (available from NIPPON AEROSIL CO., LTD.); STT-30 and STT-65C-S (both available from Titan Kogyo, Ltd.); TAF-140 (available from Fuji Titanium Industry Co., Ltd.); and MT-150W, MT-500B, MT-600B, and MT-150A (all available from TAYCA CORPORATION).

The number average particle diameter of the inorganic particles is preferably 5 nm (0.005 micrometers) or greater but 100 nm (0.1 micrometers) or less, and more preferably 0.01 micrometers or greater but 0.08 micrometers or less. When the number average particle diameter is 5 nm (0.005 micrometers) or greater, it is possible to prevent a problem that dispersibility of the inorganic particles is poor to reduce impact tenacity of a foamed body obtained. When the number average particle diameter is 100 nm (0.1 micrometers) or less, it is possible to prevent a problem that the surface of a foamed body obtained does not become smooth and has poor flexibility.

The average particle diameter of the inorganic particles may be represented as the BET specific surface area, assuming that the inorganic particles are true spheres for the sake of convenience. In such a case, the BET specific surface area is 20 m²/g or greater but 500 m²/g or less.

The amount of the inorganic particles (foam nucleating agent) may be appropriately selected depending on the intended purpose as long as the inorganic particles do not impair physical properties of the foamed body. For achieving strain hardening and high viscosity of the polylactic acid as melted, the amount of the inorganic particles is preferably 0.5% by mass or greater but 10% by mass or less, and more preferably 0.5% by mass or greater but 5% by mass or less, relative to a total amount of the foamed body. When the amount of the inorganic particles is 0.5% by mass or greater, it is possible to prevent a problem that an effect of strain hardening is small and increase in viscosity is small. When the amount of the inorganic particles is 10% by mass or less, it is possible to prevent a problem that recyclability is poor.

The amount of the inorganic particles in the foamed body of the present disclosure can be calculated from the formulated amount, but can be also analyzed by inorganic elemental analysis (O, N, H) (EA: Elemental analysis).

For example, a graphite crucible is charged with a sample together with flux, and the mixture is melted and decomposed by resistance heating of an impulse furnace in helium flow. Oxygen is detected as carbon dioxide and hydrogen is detected as moisture by an infrared detector, and nitrogen is detected as it is by a thermal conductivity detector, to be able to quantify oxygen, nitrogen, and hydrogen.

### <Other Components>

Examples of the other components include, but are not limited to, resins other than the polylactic acid resin, and additives.

<<Resins Other than Polylactic Acid Resin>>

The polylactic acid of the present disclosure may be not only polylactic acid alone, but also a blend including polylactide and another resin, or a copolymer with another resin component segment.

Although the resins other than the polylactic acid resin may be selected depending on the intended use or desired properties of the resin, examples of the resin include, but are not limited to: a biodegradable polymer; a blend with monomer components thereof (e.g., poly(3-hydroxybutylate), poly(epsilon-caprolactone), and poly(butylene succinate)); a copolymer with monomers thereof; a blend with a polyalkylene resin for imparting flexibility; a modified polylactide obtained by urethanation-crosslinking a transparent nucleating agent (e.g., a carbodiimide group-containing site, a polysiloxane site, an aliphatic carboxylic acid amide site, an aliphatic carboxylic acid site, an aliphatic alcohol site, and aliphatic carboxylic acid ester site) or (poly)ethylene oxide-added bisphenol A for improving heat resistance with an isocyanate compound in the presence of an amidation catalyst; a resin alloy obtained by blending a PET resin or PBT resin in a polylactic acid resin; a resin alloy obtained by blending polysiloxane/acrylic-based composite rubber for improving impact resistance; polylactic acid-acrylate-polysiloxane graft copolymer; vinyl pyrrolidone/L-lactic acid copolymer; sucrose/L-lactic acid copolymer; glycolic acid/L-lactic acid copolymer; and glycolide/L-lactide copolymer.

The amount of the lactic component in these blended resin, copolymer resin, or modified resin is an amount by which an obtainable effect of the present disclosure is not adversely affected, and is less than 0.5% by mass.

### <<Additives>>

The additives are not particularly limited and may be appropriately selected depending on the intended purpose. Examples thereof include, but are not limited to, a crosslinking agent, a surfactant, an antioxidant, a stabilizer, an antifog agent, a UV absorber, a pigment, a colorant, a thermal stabilizer, a flame retardant, a crystal nucleating agent, an antistatic agent, a surface wet improver, an incineration aid, a lubricant, a natural product, a release agent, a plasticizer, and other similar additives.

In view of high reactivity with the polylactic acid resin to leave only a small amount of monomers and of a low degree of coloring of the resin, the crosslinking agent is preferably a (meth)acrylic acid ester compound including two or more (meth)acrylic groups per molecule or one or more (meth)acrylic group and one or more glycidyl groups or vinyl groups per molecule is preferable. Examples of specific compounds thereof include, but are not limited to, glycidyl methacrylate, glycidyl acrylate, glycerol dimethacrylate, trimethylolpropane trimethacrylate, trimethylolpropane triacrylate, allyloxypolyethylene glycol monoacrylate, allyloxypolyethylene glycol monomethacrylate, polyethylene glycol dimethacrylate, polyethylene glycol diacrylate, polypropylene glycol dimethacrylate, polypropylene glycol diacrylate, polytetramethylene glycol dimethacrylate, copolymers of alkylene in which the alkylene glycol segment thereof has various lengths, butanediol methacrylate, and butanediol acrylate.

### <Physical Properties of Foamed Body>

The gel fraction of the foamed body varies depending on the amount of components other than the polylactic acid resin (e.g., a crosslinking agent).

The gel fraction of the foamed body is 0.1% or less and preferably 0%. When the gel fraction of the foamed body is greater than 0.1%, recyclability may be poor.

The gel fraction can be measured in the following manner.

The foamed body is accurately weighed by 50 mg, the weighed foamed body is immersed in 25 mL of chloroform at a temperature of 25 degrees Celsius for 3 hours, followed by filtering with a 200-mesh stainless steel wire mesh. The insoluble component on the wire mesh is vacuum dried.

Subsequently, the mass of the insoluble component is accurately weighed, and the gel fraction is calculated from the following formula.

Gel fraction (%)={mass of insoluble component (mg)/mass of sample weighed (mg)}×100

When the foamed body includes inorganic particles (filler), the amount of the organic particles are subtracted from the formula above to calculate the gel fraction.

The expansion ratio of the foamed body is 5 times or greater, preferably 10 times or greater. When the expansion ratio is 5 times or greater, the foamed body is light in weight and has excellent strength. When the expansion ratio is 10 times or greater, an even lighter foamed body can be obtained, and there is an advantage that a material cost is low when considering the foamed body as a material. When the expansion ratio is 10 times or greater, moreover, biodegradation of the polylactic acid resin easily proceeds as the foamed body has a large number of bubbles therein.

The expansion ratio is a value obtained by dividing the reciprocal number of the obtained bulk density (cm³/g) by the specific gravity of the polylactic acid. In the present disclosure, the specific gravity of the polylactic acid is a value determined by the following formula. Specific gravity of polylactic acid=specific gravity of polylactic acid (1.24 (no unit))×density of water (1.0 g/cm³) (the specific gravity of polylactic acid, 1.24, is a value described in (Dictionary of Chemistry (Tokyo Kagaku Dojin)).

The bulk density of the foamed body is preferably 0.02 g/cm³ or greater but 0.9 g/cm³ or less, more preferably 0.7 g/cm³ or less, and even more preferably 0.5 g/cm³ or less. When the bulk density is 0.02 g/cm³ or greater but 0.9 g/cm³ or less, a foamed body having excellent balance between strength and light weight can be obtained.

The bulk density can be evaluated according to JIS K 7365.

The foamed body of the present disclosure is light weight, has excellent heat insulation properties, is very easily molded or cut, is inexpensive, has elasticity, and has excellent shock absorption. Therefore, the foamed body can used as a buffer/wrapping material for a delicate article, and can be suitably used for heat insulation for something that needs to be kept warm or cold using heat insulation properties of the foamed body. Moreover, the foamed body can be also used for various containers, protection sheets, mirror matts, etc.

For example, the foamed body of the present disclosure may be used as the below-described foamed sheet or manufacture, or may be used after printing on the foamed body itself, or may be provided for a process for processing using a mold to obtain a product.

### (Foamed Sheet)

The foamed sheet of the present disclosure includes the foamed body of the present disclosure. The foamed sheet may further include other components according to the necessity.

The other components are not particularly limited as long as the components are used in general resin products, and may be appropriately selected depending on the intended purpose.

The average thickness of the foamed sheet is preferably 0.001 mm or greater but 4 mm or less, more preferably 1 mm or less. When the average thickness is 4 mm or less, excellent shaping processability can be obtained.

Since the foamed sheet of the present disclosure is in the finely and uniformly foamed state, the thickness of the sheet can be made thin.

When the longer side between the length of the machine direction (MD direction) of the foamed sheet and the length of the transverse direction (TD direction) of the foamed sheet is determined as a length of the long side (micrometers), a ratio (long side/thickness) of the long side to the average thickness (micrometers) is preferably 250 or greater and more preferably 2,500 or greater.

When the ratio (long side/thickness) is 250 or greater, the sheet is easily processed.

The foamed sheet of the present disclosure may be used as the below-described manufacture, may be used after printing the sheet itself, or may be provided for a process for processing using a mold to obtain a product.

The processing method of the sheet using the mold is not particularly limited, and a conventionally known method for a thermoplastic resin can be used. Examples thereof include, but are not limited to, vacuum molding, pressure molding, vacuum and pressure molding, and press molding.

At least one selected from the group consisting of a laminate layer, a coating layer, and a surface vapor deposition layer may be disposed on a front surface, or back surface, or both surfaces of the foamed sheet of the present disclosure.

Any known method can be used for laminating, coating, and surface vapor deposition. Examples of the shape of a multilayered product obtained by processing the foamed sheet include, but are not limited to, a sheet and a bottle. In the present disclosure, moreover, a multilayered sheet may be molded to form a multilayered molded product.

Examples of a production method of the multilayer product in the form of a sheet include, but are not limited to, (1) a method where a foamed sheet (A) is produced in advance, and a resin (B) extruded from a typical melt extruder is laminated on the sheet (extrusion laminate method) and (2) a method where two extruders are provided, and a polylactic acid-based resin (C) is extruded from one extruder to form a sheet and at the same time a resin (B) is extruded from the other extruder (co-extrusion method).

### (Manufacture)

The manufacture of the present disclosure includes the foamed sheet of the present disclosure, and may further include other components according to the necessity.

The other components are not particularly limited as long as the components are generally used for resin products, and may be appropriately selected depending on the intended purpose.

Examples of the product include, but are not limited to, molded products, films, particles, and fibers.

### <Molded Product>

The molded product of the present disclosure is a product obtained by processing the foamed body or foamed sheet of the present disclosure using a mold. A concept of the term “molded product” includes not only a molded product alone, but also parts formed of the molded product, such as handles of a tray, and a product equipped with the molded product, such as a tray equipped with handles.

The processing method using a mold is not particularly limited, and a conventionally known method used for a thermoplastic resin can be used as the processing method. Examples of the processing method include, but are not limited to, injection molding, vacuum molding, pressure molding, vacuum and pressure molding, and press molding.

The polylactic acid composition for use in the present disclosure is melted, and molded through injection molding to obtain a molded product. Moreover, a sheet formed of the polylactic acid composition for use in the present disclosure may be also shaped (given a shape) by press molding with a molding die to obtain a molded product.

The processing conditions for shaping are appropriately determined depending on, for example, the polylactic acid composition of the present disclosure for use, or a device for use. In the case where a sheet formed of the polylactic acid composition of the present disclosure is shaped by a molding die through press molding, for example, the temperature of the die may be set to 100 degrees Celsius or higher but 150 degrees Celsius or lower. In the case where the shaping is performed through injection molding, the polylactic acid composition of the present disclosure heated to 150 degrees Celsius or higher but 250 degrees Celsius or lower is injected into a mold, and the temperature of the mold may be set to about 20 degrees Celsius or higher but about 80 degrees Celsius or lower to perform the processing through injection molding.

### <Particles>

Examples of a method for forming the polylactic acid composition of the present disclosure into particles include, but are not limited to, a method where the polylactic acid composition of the present disclosure is pulverized according to any conventionally known method in the art.

The average particle diameter of the particles is not particularly limited and may be appropriately selected depending on the intended purpose. The average particle diameter thereof is preferably 1 micrometer or greater but 50 micrometers or less.

In the case where the particles are a toner for electrophotography, a mixture where a colorant and hydrophobic particles are mixed in the polylactic acid composition is prepared. The mixture may include, in addition to a binder resin, the colorant, and the hydrophobic particles, and other additives. Examples of the other additives include, but are not limited to, a release agent and a charging controlling agent. A step of mixing the additives may be performed at the same time as polymerization reaction. Alternatively, the additives may be added during a post-step after the polymerization reaction or may be added with melt kneading after taking the polymerized product out from the system.

### <Film>

The film of the present disclosure is the polylactic acid composition of the present disclosure formed into a thin film, and has a thickness of less than 250 micrometers. The film is produced by stretch-molding the polylactic acid composition.

In this case, the stretch molding is not particularly limited, but uniaxial stretch molding, or simultaneous or sequential biaxial stretch molding (e.g., the tubular method and the tenter method) applied for stretch molding of general plastics can be employed.

Film forming is typically performed at a temperature ranging from 150 degrees Celsius through 280 degrees Celsius. Monoaxial or biaxial stretching is performed on the formed film by the roll method, tenter method, tubular method, etc. The stretching temperature is preferably from 30 degrees Celsius through 110 degrees Celsius and more preferably from 50 degrees Celsius through 100 degrees Celsius. The stretching ratio is typically preferably from 0.6 times through 10 times in both the longitudinal and lateral directions. After stretching, moreover, a heat treatment may be performed by a method of blowing hot air, a method of radiating infrared rays, a method of radiating microwaves, or a method of bringing the stretched product into contact with a heat roll.

According to the above stretch molding, various stretched films, such as a stretched sheet, flat yarn, a stretched tape, a stretched band, tape with streaks, and split yarn, can be obtained. The thickness of the stretched film is not particularly limited and may be appropriately selected depending on the intended purpose. The thickness thereof is preferably 5 micrometers or greater but less than 250 micrometers.

Secondary processing may be performed for the purpose of providing the stretched film with, for example, chemical functions, electrical functions, magnetic functions, mechanical functions, friction/abrasion/lubricant functions, optical functions, thermal functions, and surface functions such as biocompatibility. Examples of the secondary processing include, but are not limited to, embossing, coating, bonding, printing, metalizing (e.g., plating), mechanical processing, and a surface treatment (e.g., an antistatic treatment, a corona discharge treatment, a plasma treatment, a photochromism treatment, physical vapor deposition, chemical vapor deposition, and coating).

The stretched film can be applied for various uses, such as commodities, wrapping materials, medicines, materials for electrical devices, housing for home appliances, and materials for automobiles.

### <Fibers>

The polylactic acid composition of the present disclosure can be also applied as fibers, such as monofilaments and multi-filaments. A concept of the term “fibers” includes not only fibers alone, such as monofilaments, but also intermediate products formed of fibers, such as woven fabrics and non-woven fabrics, or products including woven fabrics and non-woven fabrics, such as masks.

In the case of monofilaments, the fibers can be produced by melt spinning, cooling, and stretching the polylactic acid composition of the present disclosure to form the composition into fibers according to any conventionally known method in the art. Depending on the use thereof, a coating layer may be formed on the monofilament according to any conventionally known method in the art, and the coating layer may include an antibacterial agent, a colorant, etc. In the case of being formed into the non-woven fabric, examples of production methods thereof include, but are not limited to, a method including melt spinning, cooling, stretching, opening fibers, depositing, and heat treating according to any conventionally known method in the art.

### (Method for Producing Foamed Body)

The method of the present disclosure for producing a foamed body includes a kneading step and a foaming step. The method may further include other steps according to the necessity. The kneading step and the foaming step may be performed simultaneously or may be performed as separate steps.

### <Kneading Step>

The kneading step is a step of kneading the polylactic acid resin and the inorganic particles in the presence of the compressive fluid at a temperature lower than a melting point of the polylactic acid resin.

In the kneading step, a foaming agent may be added in addition to the polylactic acid resin and the inorganic particles in order to facilitate efficient foaming.

The mixture including the polylactic acid resin, the inorganic particles, and the foaming agent before foaming may be referred to as a polylactic acid composition or a masterbatch.

### <<Foaming Agent>>

In terms of the ability to easily produce a polylactic acid-based resin foamed sheet having a high expansion ratio, examples of the foaming agent include, but are not limited to, hydrocarbons, such as lower alkanes (e.g., propane, normal butane, isobutane, normal pentane, isopentane, and hexane), ethers (e.g., dimethyl ether), halogenated hydrocarbons (e.g., methyl chloride and ethyl chloride), and physical foaming agents, such as compressive gas of carbon dioxide, nitrogen, etc.

Of these, use of a compressive gas of carbon dioxide, nitrogen, etc. is preferable because the compressive gas has no odor, is safely handled, and gives low environmental loads.

Aliphatic polyester, as represented by the polylactic acid, has properties that melt viscosity thereof drastically decreases at a melting point thereof or higher temperatures. When the aliphatic polyester is kneaded with inorganic particles (a foam nucleating agent, filler, etc.), the foam nucleating agent easily aggregates. This phenomenon is significant when the size of the filler is small.

In the present disclosure, kneading is performed using a compressive fluid in order to homogeneously disperse the filler in the polylactic acid. It is preferable as a production embodiment in terms of reduction in environmental loads that the compressive fluid be identical to the foaming agent. This is because kneading with filler and foaming can be performed as a series of processes.

A reason why use of a compressive fluid in kneading the filler and the aliphatic polyester resin is preferable will be described below.

It is known that a resin is generally plasticized by a compressive fluid to decrease in melt viscosity (see “Latest applied technology of supercritical fluid,” NTS Inc.). A decrease in the melt viscosity and an improvement in the kneading performance seem to be contradictory. Actually, a pressure may be applied without using the compressive fluid for kneading general filler, but this decreases the free volume of the resin to aim at an increase in interaction between the resins (increase in viscosity), which is opposite to plasticization of the resin (see “k. Yang. R. Ozisik R. Polymer, 47. 2849 (2006)”).

Hitherto, it has been known that a compressive fluid has such a property as to plasticize (soften) a resin, and the resin behaves like a liquid in the compressive fluid at an increased temperature. Dispersing the filler in the resin in such a state is like dispersing the filler in a liquid. As a result, the filler aggregates in the liquid to be unable to obtain a highly dispersed resin composition. In other words, the resin cannot have a suitable viscosity for kneading in the presence of the compressive fluid, and thus it has been considered difficult to use the compressive fluid for kneading the resin and the filler.

Under such circumstances, the present inventors intensively studied whether the compressive fluid can be used for kneading between the polylactic acid resin and the filler, and have found that the polylactic acid resin has a suitable viscosity for kneading at a temperature lower than the melting point of the polylactic acid resin in the presence of the compressive fluid, resulting in being able to knead the filler. In particular, the polylactic acid, the melt viscosity of which drastically decreases at a temperature equal to or higher than the melting point, enabled kneading only in the state of low melt viscosity. In the present disclosure, meanwhile, the filler can be kneaded in the state of high viscosity, and also the compressive fluid can be used as the foaming agent as is, which is more suitable.

### <<Compressive Fluid>>

Examples of a substance that can be used in a state of the compressive fluid include, but are not limited to, carbon monoxide, carbon dioxide, dinitrogen monoxide, nitrogen, methane, ethane, propane, 2,3-dimethylbutane, ethylene, and dimethyl ether. Of these, carbon dioxide is preferable because the critical pressure and critical temperature of carbon dioxide are about 7.4 MPa and about 31 degrees Celsius, respectively, and thus a supercritical state of carbon dioxide is easily created. In addition, carbon dioxide is non-flammable and easily handled. These compressive fluids may be used alone or in combination.

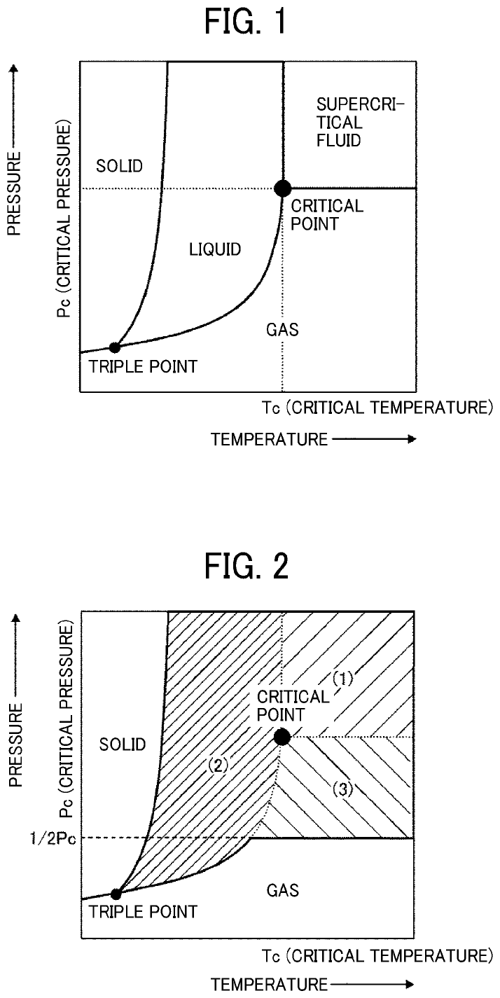

Referring now to FIG. 1 and FIG. 2, description will be given to the compressive fluid used for producing the polylactic acid resin. FIG. 1 is a phase diagram illustrating the state of a substance depending on pressure and temperature. FIG. 2 is a phase diagram which defines a range of a compressive fluid. The “compressive fluid” in the present embodiment refers to a state of a substance present in region (1), (2), or (3) of FIG. 2 in the phase diagram illustrated in FIG. 1.

In such regions, the substance is known to have extremely high density and show different behaviors from those observed at normal temperature and normal pressure. Note that, the substance in the region (1) is a supercritical fluid. The supercritical fluid is a fluid that exists as a non-condensable high-density fluid at temperature and pressure exceeding limits (critical points) at which a gas and a liquid can coexist and that does not condense even when compressed. The substance in the region (2) turns into a liquid but represents a liquefied gas obtained by compressing a substance existing as a gas at normal temperature (25 degrees Celsius) and normal pressure (1 atm). The substance is in the region (3) is in the state of a gas but represents a high-pressure gas having a pressure that is ½ or higher of the critical pressure (Pc), i.e. ½ Pc or higher.

Solubility of the compressive fluid varies depending on the combination of the resin and the compressive fluid, temperature, and pressure. Thus, there is a need to appropriately adjust the amount of the compressive fluid supplied.

For example, in the combination of polylactic acid and carbon dioxide, the amount of the carbon dioxide supplied is preferably 2% by mass or more but 30% by mass or less. When the amount of the carbon dioxide supplied is 2% by mass or more, it is possible to prevent a problem that an obtainable plasticizing effect is limitative. When the amount of the carbon dioxide supplied is 30% by mass or less, it is possible to prevent a problem that the carbon dioxide and the polylactic acid are phase-separated to be unable to obtain the foamed sheet having a uniform thickness.

### <<Kneading Device>>

As a kneading device used for producing the polylactic acid composition of the present disclosure, a continuous process may be employed or a batch process may be employed. Preferably, a reaction process is appropriately selected by considering, for example, efficiency of a device, characteristics of a product, and quality.

In terms of the ability to achieve the viscosity suitable for kneading, the kneading device usable is, for example, a single screw extruder, a twin screw extruder, a kneader, a screw-less basket-shaped stirring vessel, BIVOLAK (available from Sumitomo Heavy Industries, Ltd.), N-SCR (available from Mitsubishi Heavy Industries, Ltd.), or a tube-shaped polymerization vessel equipped with a spectacle-shaped blade (available from Hitachi, Ltd.), lattice-blade or Kenix-type, or Sulzer-type SMLX-type static mixer. In terms of color tone, the kneading device usable is a finisher that is a self-cleaning-type polymerization apparatus, N-SCR, or a twin-screw extruder. Among them, a finisher and N-SCR are preferable in terms of production efficiency, color tone of a resin, stability, and heat resistance.

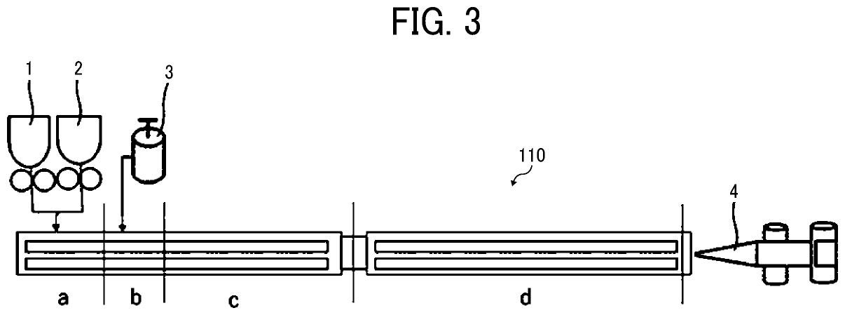

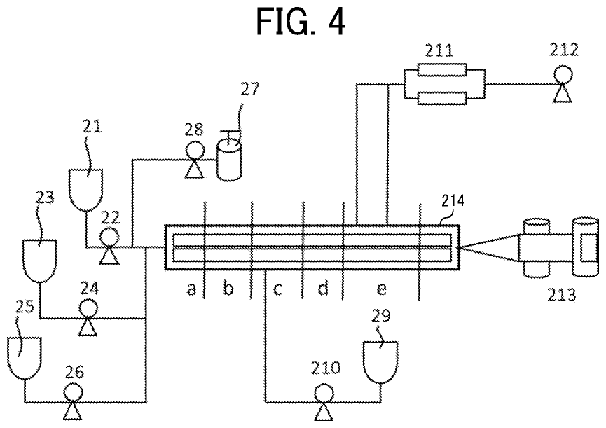

As illustrated in FIG. 3, a continuous kneading device 110 includes a twin screw extruder (available from JSW, screw caliber: 42 mm, L/D=48, Device 1), a raw material mixing and melting area a (Device 2), a compressive fluid supplying area b (Device 3), a kneading area c, a molding area d, and a T-die 4. A compressive fluid (liquid material) is supplied by a metering pump. Solid raw materials such as the resin and the inorganic particles are supplied by a quantitative feeder.

### <<Raw Material Mixing and Melting Area>>

In the raw material mixing and melting area, the resin and the inorganic particles are mixed and heated. The heating temperature is set to a temperature that is equal to or higher than the melting temperature of the resin, which makes it possible to uniformly mix the mixture with a compressive fluid in a subsequent area where the compressive fluid is to be supplied.

### <<Compressive Fluid Supplying Area>>

The resin is turned into a melted state upon heating, and the compressive fluid is supplied in the state that the inorganic particles are wetted, to thereby plasticize the melted resin.

### <<Kneading Area>>

The temperature in the kneading area is set so that the viscosity suitable for kneading the inorganic particles is achieved. The set temperature is not particularly limited because the temperature varies depending on, for example, the specification of a reaction device, the kind of a resin, the structure of the resin, and the molecular weight of the resin. For commercially available polylactic acid having a weight average molecular weight (Mw) of about 200,000, the kneading is usually performed at a temperature that is the melting point of the polylactic acid plus 10 degrees Celsius or greater but 20 degrees Celsius or less. In the present disclosure, it is possible to perform the kneading at a relatively high viscosity at a temperature lower than the melting point of the polylactic acid. Specifically, the temperature for the kneading is the melting point of the polylactic acid minus 20 degrees Celsius or greater but 80 degrees or less, and more preferably minus 30 degrees Celsius or greater but 60 degrees Celsius or less.

Conveniently, the temperature may be set with reference to a current value of stirring power of a device, but the set value is in a region that cannot be typically reached, unless by the present disclosure.

### <Foaming Step>

The foaming step is a step of removing the compressive fluid to foam the polylactic acid composition.

The compressive fluid can be removed by releasing the pressure.

The temperature during the foaming step is preferably a temperature equal to or higher than the melting point of the polylactic acid resin.

In the foaming step, the compressive fluid dissolved in the polylactic acid composition vaporizes and precipitates at the interfaces with the inorganic particles, to thereby generate foams in response to a treatment to change solubility of the compressive fluid, such as pressure reduction and heating. The foaming starts from the inorganic particles. Thus, only when the inorganic particles are homogeneously dispersed in the polylactic acid, a foamed body including uniform and fine foams can be produced.

### <Other Steps>

The other steps are not particularly limited and may be appropriately selected depending on the intended purpose as long as they are steps typically performed in the production of a foamed body. Examples thereof include, but are not limited to, a molding step of forming into a sheet.

Examples of the molding step include, but are not limited to, vacuum molding, pressure molding, and press molding. The molding step yields a molded product in the form of a sheet.

### EXAMPLES

The present disclosure will be described below by way of Examples. The present disclosure should not be construed as being limited to these Examples.

### <Synthesis of Polylactic Acid Resin (A)>

A polylactic acid resin was produced by means of a device illustrated in FIG. 5. FIG. 5 is a view illustrating a device including a monomer tank 21, a monomer pump 22, a catalyst tank 23, a catalyst pump 24, an initiator tank 25, an initiator pump 26, a cylinder for compressive fluid 27, a pump for compressive fluid 28, an additive tank 29, an additive pump 210, a trap 211, a vacuum pump 212, a T-die 213, and a biaxial roller 214. L-lactide (obtained from Purac Japan) serving as a monomer was supplied at a feeding rate of 1 kg/hr, 1-hexanol (obtained from FUJIFILM Wako Pure Chemical Corporation) serving as an initiator was supplied at a feeding rate of 0.01 g/hr, tin 2-octylate (obtained from FUJIFILM Wako Pure Chemical Corporation) serving as a catalyst was supplied at a feeding rate of 0.5 g/hr, CO₂ (obtained from SHOWA DENKO GAS PRODUCTS CO., LTD., purity: 99.999%) serving as a compressive fluid 1 was supplied at a feeding rate of 50 g/hr, methyltriethoxysilane (obtained from Shin-Etsu Chemical Co., Ltd.) serving as a metal oxide precursor was supplied at a feeding rate of 0.05 g/hr, and CO₂ (obtained from SHOWA DENKO GAS PRODUCTS CO., LTD., purity: 99.999%) serving as a compressive fluid 2 was supplied at a feeding rate of 10 g/hr to allow the monomer to polymerize for 60 minutes, to thereby obtain polylactic acid resin (A).

The temperatures of the respective zones were set as follows: the raw material mixing area a: 170 degrees Celsius; pre-polymerization area b: 170 degrees Celsius; nucleating agent growth area c: 90 degrees Celsius; main polymerization area d: 180 degrees Celsius; and monomer removing area e: 185 degrees Celsius.

The pressure of the respective zones was set as follows: zone from the inlet of the extruder to the main polymerization area d: 10 MPa, the monomer removing area e: 0.05 kPa; and the T-die 213: 5 MPa.

### <Synthesis of Polylactic Acid Resins (B) to (D)>

Polylactic acid resins (B) to (D) were synthesized in the same manner as in the synthesis of polylactic acid resin (A), except that the initiator feeding rate, the metal catalyst feeding rate, and the polymerization time were changed as presented in Table 1.

### <Synthesis of Polylactic Acid Resins (E) and (F)>

Polylactic acid resins (E) and (F) were synthesized in the same manner as in the synthesis of polylactic acid resin (A), except that the feeding rate of L-lactide (obtained from Purac Japan) was changed to 0.995 kg/hr, hexamethylene diisocyanate (product name: H0324, obtained from Tokyo Chemical Industry Co., Ltd.) serving as a crosslinking agent was added at a feeding rate of 0.005 kg/hr, and the other conditions were changed as presented in Table 1.

The weight average molecular weight of each of the obtained polylactic acid resins (A) to (F) was measured by gel permeation chromatography (GPC) in the following manner.

Device: GPC-8020 (obtained from Tosoh Corporation)

Columns: TSK G2000HXL and G4000HXL (obtained from Tosoh Corporation)

Temperature: 40 degrees Celsius

Solvent: chloroform

Flow rate: 1.0 mL/min

A sample (1 mL) having a concentration of 0.5% by mass was applied, and a weight molecular weight Mw of polylactic acid was calculated from a molecular weight distribution of the polylactic acid as measured under the above conditions, using a molecular weight calibration curve prepared from monodisperse polystyrene standard samples.

TABLE 1

| | Weight average | Initiator | Catalyst | | Polymerization |
|---|---|---|---|---|---|
| | molecular weight | feeding rate | feeding rate | Crosslinking | time |
| | (Mw) ×10³ | (g/h) | (g/h) | agent | (min) |
| A | 260 | 0.01 | 0.5 | — | 60 |
| B | 380 | 0.01 | 0.5 | — | 90 |
| C | 700 | 0.005 | 0.5 | — | 90 |
| D | 220 | 0.01 | 0.4 | — | 30 |
| E | 800 | 0.01 | 0.5 | hexamethylene | 90 |
| | | | | diisocyanate | |
| F | 240 | 0.01 | 0.4 | hexamethylene | 30 |
| | | | | diisocyanate | |

### Example 1

### <Foamed Body and Production of Foamed Sheet>

As inorganic particles (A), hydrophobic-treated silica (QSG-30, average particle diameter: 30 nm, obtained from Shinetsukogyo Co., Ltd.) was used.

By means of the continuous foaming device 110 illustrated in FIG. 3, inorganic particles (A) and polylactic acid resin (A) were supplied so that the feeding rate would be 10 kg/hr in total. Carbon dioxide serving as a compressive fluid was supplied at 2.99 kg/hr (equivalent to 30% by mass relative to the polylactic acid) with polylactic acid (A) supplied at 9.97 kg/hr, and the inorganic particles supplied at 0.03 kg/hr so that the amount of the inorganic particles would be 0.3% by mass. The resultant was kneaded and provided to a second extruder. The polylactic acid composition was extruded from a circular mold, disposed at an edge of the second extruder and having a slit diameter of 70 mm, at a discharge amount of 10 kg/hr and cooled to a resin temperature of 167 degrees Celsius, to thereby extrude and foam the polylactic acid composition. The cylindrical polylactic acid resin foamed sheet extruded from the mold slit and foamed was placed along a cooled mandrel with blowing air onto the outer surface of the polylactic acid resin foamed sheet from an air ring to cool and form the foamed sheet. The resultant was cut open to obtain a foamed body (foamed sheet) in the form of a flat sheet having a thickness of 4 mm.

The temperatures of the respective zones of the first extruder were set as follows: raw material mixing and melting area a and compressive fluid supplying area b: 190 degrees Celsius, and kneading area c: 150 degrees Celsius. The temperature of the second extruder heating area d was set to 167 degrees Celsius. As the pressure of the respective zones, the zone from the compressive fluid supply area b to the kneading area c and the second extruder heating area d was set to 7.0 MPa.

### Example 2

A foamed body of Example 2 was obtained in the same manner as in Example 1, except that the inorganic particles, polylactic acid resin (A) and 2,6-di-t-butyl-4-methylphenol serving as the antioxidant were supplied so that the feeding rate would be 10 kg/hr in total, and the feeing rate of the polylactic acid resin (A) was changed to 9.92 kg/hr, and the feeding rate of the 2,6-di-t-butyl-4-methylphenol was changed to 0.05 kg/hr so that the amount of the inorganic particles would be 0.3% by mass.

### Example 3

A foamed body of Example 3 was obtained in the same manner as in Example 1, except that polylactic acid resin (A) was replaced with polylactic acid resin (B).

### Example 4

A foamed body of Example 4 was obtained in the same manner as in Example 1, except that polylactic acid resin (A) was replaced with polylactic acid resin (B) and the amount of the inorganic particles was changed to 0.5% by mass.

### Example 5

A foamed body of Example 5 was obtained in the same manner as in Example 1, except that polylactic acid resin (A) was replaced with polylactic acid resin (B) and the amount of the inorganic particles was changed to 5% by mass.

### Example 6

A foamed body of Example 6 was obtained in the same manner as in Example 1, except that polylactic acid resin (A) was replaced with polylactic acid resin (C) and the amount of the inorganic particles was changed to 0.5% by mass.

### Example 7

A foamed body of Example 7 was obtained in the same manner as in Example 1, except that polylactic acid resin (A) was replaced with polylactic acid resin (B) and the amount of the inorganic particles was changed to 10% by mass.

### Example 8

A foamed body of Example 8 was obtained in the same manner as in Example 1, except that polylactic acid resin (A) was replaced with polylactic acid resin (F).

### Comparative Example 1

A foamed body of Comparative Example 1 was obtained in the same manner as in Example 1, except that polylactic acid resin (A) was replaced with polylactic acid resin (E).

### Comparative Example 2

A foamed body of Comparative Example 2 was obtained in the same manner as in Example 1, except that the inorganic particles, polylactic acid resin (A) and 2,6-di-t-butyl-4-methylphenol serving as the antioxidant were supplied so that the feeding rate would be 10 kg/hr in total, and the feeding rate of polylactic acid resin (A) was changed to 9.87 kg/hr and the feeding rate of the 2,6-di-t-butyl-4-methylphenol was changed to 0.1 kg/hr so that the amount of the inorganic particles would be 0.3% by mass.

### Comparative Example 3

A foamed body of Comparative Example 3 was obtained in the same manner as in Example 1, except that polylactic acid resin (A) was replaced with polylactic acid resin (B) and the feeding rate of carbon dioxide serving as the compressive fluid was changed to 1.99 kg/hr (equivalent to 20% by mass relative to the polylactic acid).

### Comparative Example 4

A foamed body of Comparative Example 4 was obtained in the same manner as in Example 1, except that polylactic acid resin (A) was replaced with polylactic acid resin (D).

### Comparative Example 5

A foamed body of Comparative Example 5 was obtained in the same manner as in Example 1, except that the inorganic particles, polylactic acid resin (A) and 2,6-di-t-butyl-4-methylphenol serving as the antioxidant were supplied so that the feeding rate would be 10 kg/hr in total, and the feeding rate of polylactic acid resin (A) was changed to 9.93 kg/hr and the feeding rate of the 2,6-di-t-butyl-4-methylphenol was changed to 0.04 kg/hr so that the amount of the inorganic particles would be 0.3% by mass.

### <Measurement of Gel Fraction>

The obtained foamed body was accurately weighed by 50 mg, the weighed foamed body was immersed in 25 mL of chloroform at a temperature of 25 degrees Celsius for 3 hours, followed by filtering with a 200-mesh stainless steel wire mesh. The insoluble component on the wire mesh was vacuum dried.

Subsequently, the insoluble component was accurately weighed, and the gel fraction was calculated by the following formula. The calculated results are presented in Table 2.

Gel fraction (%)={mass of insoluble component (mg)/mass of sample weighed (mg)}×100−inorganic particles content (% by mass)

### <Measurement of Expansion Ratio>

The bulk density of the obtained foamed body was measured according to JIS K 7365. The expansion ratio was calculated by dividing the obtained bulk density by the specific gravity of polylactic acid (1.24 g/cm³). The calculated results are presented in Table 2.

TABLE 2

| | | Weight | | | | |
|---|---|---|---|---|---|---|
| | | average | Polylactic | | | |
| | | molecular | acid content | Amount of | | |
| | | weight of | in organic | inorganic | | Expansion |
| | Polylactic | polylactic acid | matter | particles | Gel fraction | ratio |
| | acid | (Mw) ×10³ | (%) | (%) | (%) | (times) |
| Ex. 1 | A | 260 | 100.0 | 0.3 | 0.0 | 5.0 |
| Ex. 2 | A | 260 | 99.5 | 0.3 | 0.0 | 5.0 |
| Ex. 3 | B | 380 | 100.0 | 0.3 | 0.0 | 7.0 |
| Ex. 4 | B | 380 | 100.0 | 0.5 | 0.0 | 8.0 |
| Ex. 5 | B | 380 | 100.0 | 5.0 | 0.0 | 10.0 |
| Ex. 6 | C | 700 | 100.0 | 0.5 | 0.1 | 12.0 |
| Ex. 7 | B | 380 | 100.0 | 10.0 | 0.0 | 12.0 |
| Ex. 8 | F | 240 | 99.5 | 0.3 | 0.1 | 5.0 |
| Comp. Ex, 1 | E | 800 | 99.5 | 0.3 | 0.2 | 7.0 |
| Comp. Ex. 2 | A | 260 | 99.0 | 0.3 | 0.0 | 5.0 |
| Comp. Ex. 3 | B | 260 | 100.0 | 0.3 | 0.0 | 4.5 |
| Comp. Ex. 4 | D | 220 | 100.0 | 0.3 | 0.0 | 3.5 |
| Comp. Ex. 5 | A | 260 | 99.4 | 0.3 | 0.0 | 6.5 |

The recyclability, strength (resistance), and flexibility of the obtained foamed body were evaluated by the following methods. The evaluation results are presented in Table 3.

### <Recyclability>

As for recyclability, the most important factor is that the foamed body is formed of a single material. Even though polylactic acid is biodegraded, if the other components remain, such a foamed body is not preferable in view of recyclability. In the present disclosure, therefore, the uniformity of components in the organic matter was evaluated according to the following evaluation criteria.

The foamed body, in which the total amount of the gel component that was difficult to biodegrade and the inorganic particles was 5% by mass or greater was downgraded by one rank in the evaluation. A reason why the foamed body having a large amount of the inorganic particles added was downgraded in the evaluation was because a recycling efficiency became lower with the large amount of the inorganic particles even through the inorganic particles could be easily separated from the organic matter.

### -Evaluation Criteria-

A: 100% of the organic matter had biodegradability, and the amount of the inorganic particles was 0.5% or less.

B: 100% of the organic matter had biodegradability.

C: 99.5% or greater of the organic matter had biodegradability.

D: Less than 99.5% of the organic matter had biodegradability.

### <Strength (Resistance)>

The resistance was evaluated based on a bending elastic modulus. The bending elastic modulus was measured according to JIS K 7171 to obtain an analytic value of the tangent method (initial tangential gradient of the stress-strain curve), and the result was evaluated according to the following evaluation criteria. The larger value of the bending elastic modulus indicates the higher bending elastic modulus and higher strength.

### -Evaluation Criteria-

A: greater than 2,100 MPa
B: 1,401 MPa or greater but 2,100 MPa or less
C: 1,200 MPa or greater but 1,400 MPa or less
D: less than 1,200 MPa

### <Flexibility>

Flexibility was evaluated according to the tensile-impact strength testing method (JIS K 7160 A) according to the following evaluation criteria. The larger value indicates capability of resisting the greater impact, and is more preferable.

### -Evaluation Criteria-

A: greater than 26 kJ/m²
B: 21 kJ/m² or greater but 26 kJ/m² or less
C: 13 kJ/m² or greater but 20 kJ/m² or less
D: less than 13 kJ/m²

### <Comprehensive Evaluation>

The comprehensive evaluation was performed according to the following evaluation criteria. The results are presented in Table 3.

In each evaluation item, the evaluation result A was determined as 3 points, B was determined as 2 points, C was determined as 1 point, and D was determined as −3 points. The comprehensive evaluation was performed based on the total points according to the following evaluation criteria.

### -Evaluation Criteria-

A: The total point was 7 points or greater.

B: The total point was 4 points or greater but 6 points or less.

C: The total point was 1 point or greater but 3 points or less.

D: The total point was 0 points or less.

TABLE 3

| | | | Flexibility | |
|---|---|---|---|---|
| | | Strength | (impact | Comprehensive |
| | Recyclability | (resistance) | resistance) | evaluation |
| Ex. 1 | A | C | B | B |
| Ex. 2 | C | C | C | C |
| Ex. 3 | B | B | C | B |
| Ex. 4 | B | B | B | B |
| Ex. 5 | B | A | A | A |
| Ex. 6 | C | A | A | A |
| Ex. 7 | B | A | A | A |
| Ex. 8 | C | B | B | B |
| Comp. Ex. 1 | D | A | B | D |
| Comp. Ex. 2 | D | C | C | D |
| Comp. Ex. 3 | A | B | D | D |
| Comp. Ex. 4 | A | D | D | D |
| Comp. Ex. 5 | D | C | C | D |

Embodiments of the present disclosure are as follows, for example.

<1> A foamed body including

a polylactic acid resin,

wherein an amount of the polylactic acid resin is 99.5% by mass or greater relative to a total amount of organic matter in the foamed body,

a gel fraction of the foamed body is 0.1% or less, and

an expansion ratio of the foamed body is 5 times or greater.

<2> The foamed body according to <1> above, further including inorganic particles in an amount of 0.5% by mass or greater but 10% by mass or less.
<3> The foamed body according to <1> or <2> above, wherein a weight average molecular weight (Mw) of the polylactic acid resin is 260,000 or greater.
<4> The foamed body according to any one of <1> to <3>,

wherein the expansion ratio is 10 times or greater.

<5> A foamed sheet including

the foamed body according to any one of <1> to <4> above.

<6> The foamed sheet according to <5> above,

wherein an average thickness of the foamed sheet is 0.001 mm or greater but 4 mm or less.

<7> The foamed sheet according to <5> or <6> above, further including

at least one selected from the group consisting of a laminate layer, a coating layer, and a surface vapor deposition layer, at a front surface or a back surface of the foamed sheet or both the front surface or the back surface of the foamed sheet.

<8> A manufacture including

the foamed sheet according to any one of <5> to <7> above.

<9> The manufacture according to <8> above,

wherein the manufacture is at least one selected from the group consisting of molded products, films, particles, and fibers.

<10> A method for producing a foamed body, the method including:

kneading a polylactic acid resin and inorganic particles in presence of a compressive fluid at a temperature lower than a melting point of the polylactic acid resin to obtain a polylactic acid resin composition; and

removing the compressive fluid from the polylactic acid resin composition and foaming the polylactic acid resin composition.

The foamed body according to any one of <1> to <4> above, the foamed sheet according to any one of <5> to <7> above, the manufacture according to <8> or <9> above, and the method for producing a foamed body according to <10> can solve the above-described various problems in the art and can achieve the object of the present disclosure.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

This patent application is based on and claims priority to Japanese Patent Application No. 2020-130964, filed on Jul. 31, 2020, the entire disclosure of which is hereby incorporated by reference herein.

### REFERENCE SIGNS LIST

1 Resin pellet supply tank
2 Inorganic particles supply tank
3 Compressive fluid supply tank
4 T-die
110 Continuous foaming device
21 Monomer tank
22 Monomer pump
23 Catalyst tank
24 Catalyst pump
25 Initiator tank
26 Initiator pump
27 Cylinder for compressive fluid
28 Pump for compressive fluid
29 Additive tank
210 Additive pump
211 Trap
212 Vacuum pump
213 T-die
214 Biaxial roller

1. A foamed body, comprising:
a polylactic acid resin,
wherein an amount of the polylactic acid resin is 99.5% by mass or greater relative to a total amount of organic matter in the foamed body,
a gel fraction of the foamed body is 0.1% or less, and
an expansion ratio of the foamed body is 5 times or greater.

2. The foamed body according to claim 1, further comprising:
inorganic particles in an amount of 0.5% by mass or greater but 10% by mass or less.

3. The foamed body according to claim 1, wherein a weight average molecular weight (Mw) of the poly lactic acid resin is 260,000 or greater.

4. The foamed body according to claim 1, wherein the expansion ratio is 10 times or greater.

5. A foamed sheet, comprising:
the foamed body according to claim 1.

6. The foamed sheet according to claim 5, wherein an average thickness of the foamed sheet is 0.001 mm or greater but 4 mm or less.

7. The foamed sheet according to claim 5, further comprising:
at least one selected from the group consisting of a laminate layer, a coating layer, and a surface vapor deposition layer, at a front surface or a back surface of the foamed sheet or at both the front surface and the back surface of the foamed sheet.

8. A manufacture, comprising:
the foamed sheet according to claim 5.

9. The manufacture according to claim 8, wherein the manufacture is at least one selected from the group consisting of molded products, films, particles, and fibers.

10. A method for producing a foamed body, the method comprising:
kneading a polylactic acid resin and inorganic particles in presence of a compressive fluid at a temperature lower than a melting point of the polylactic acid resin to obtain a polylactic acid resin composition; and
removing the compressive fluid from the polylactic acid resin composition and foaming the polylactic acid resin composition.
